(19) United States
(12) Patent Application Publication
(10) Pub. No.: US 2024/0373822 A1
(43) Pub. Date: Nov. 14, 2024

(54) DAYTIME ANIMAL FEEDER

(71) Applicant: DEADFALL LLC, Peru, IL (US)

(72) Inventors: Matt Busbice, Peru, IL (US); Matt Pell, Peru, IL (US); Tony Cain, Peru, IL (US)

(21) Appl. No.: 18/782,089

(22) Filed: Jul. 24, 2024

Related U.S. Application Data
(63) Continuation of application No. PCT/US23/11751, filed on Jan. 27, 2023.
(60) Provisional application No. 63/303,824, filed on Jan. 27, 2022.

(51) Int. Cl. A01K 5/02

(52) U.S. Cl. CPC A01K 5/0291

(57) ABSTRACT

A daytime animal feeder includes a storage housing with a wall arrangement and at least one openable door coupled to the wall arrangement. The feeder further includes an actuator mechanism configured to move the at least one openable door between a closed position and an open position to allow a desirable, preferred animal to access feed located within the storage housing. The feeder further includes a control system configured to control operation of the actuator mechanism to open and close the at least one openable door when predefined conditions are met or manually activated by a user. The daytime animal feeder includes a number of components and features that are purposely designed to interact and provide improved daytime feeder performance including, but not limited to, preventing (i) unscheduled, uncontrolled feeding, (ii) water and/or moisture from penetrating or migrating into the storage housing and damaging the animal feed therein, even when the at least one door is in either the closed position or the open position, and (iii) an undesirable, un-preferred animal from breaching the housing to gain access to the feed therein.

### PRIORITY CLAIM

This application is a continuation of PCT Application Serial No. PCT/US23/11751, filed Jan. 27, 2023, which claims the benefit of U.S. Provisional Application Ser. No. 63/303,824, filed Jan. 27, 2022, the disclosure of which both is hereby incorporated by reference in its entirety for all purposes.

### TECHNICAL FIELD

The present disclosure relates to a daytime animal feeder, such as a game animal, with at least one openable door and an actuator mechanism with a control system configured to selectively open and close the at least one door to enable a desirable, preferred animal to access feed located within the feeder. The inventive daytime animal feeder prevents (i) an unscheduled, uncontrolled feeding, (ii) water and/or moisture from penetrating or migrating into the storage housing and damaging the feed therein, even when the at least one door is in either a closed position P_{C} or an open position P_{O}, and, (iii) an undesirable, un-preferred animal from breaching the housing to gain access to the feed.

### BACKGROUND

Animal feeders, including automatic animal feeders, are known in the art and are designed to attract certain animals to the immediate area where the feeder is located. Conventional automatic feeders suffer from a number of limitations that negatively impact their utility, durability, and functionality. For example, conventional feeders do not reliably limit access to feed during pre-determined time periods. In addition, conventional feeders are poorly designed and/or constructed and thereby are prone to allow water (e.g., rain) or moisture (e.g., humidity) into the feeder which damages the feed stored therein. This damage can lead to rotting or destruction of the feed, which will deter the desired game from utilizing the feeder. Conventional feeders are also designed in a manner that makes them visually obvious to the game animal, which also deters the game animal from utilizing the feeder. Consequently, conventional automatic feeders do not effectively “train” animals to consistently return to the feeder where the hunter is situated.

The inventive daytime animal feeder addresses the shortcomings and limitations discussed above and other problems, while providing advantages and aspects not contained by prior art animal feeders. A full discussion of the features and advantages of the present disclosure is deferred to the following detailed description, which proceeds with reference to the accompanying drawings.

### SUMMARY OF THE INVENTION

The present disclosure is directed to an animal feeder that provides controlled feeding for an animal. The animal feeder includes a wall arrangement defining a housing configured to store animal feed. The housing includes: (i) a front wall with a front wall aperture defined by an aperture frame of the front wall, (ii) a front openable door pivotally coupled to the housing and overlying both the front wall aperture and the aperture frame of the front wall, (ii) a rear wall with a rear wall aperture defined by an aperture frame of the rear wall, and (iv) a rear openable door pivotally coupled to the housing and overlying both the rear wall aperture and the aperture frame of the rear wall.

The animal feeder also includes an actuator configured to pivotally move both the front openable door and the rear openable door between a closed position and an open position. A control system is configured to control operation of the actuator in response to one or more predefined conditions, including but not limited to: the time of day, the day of the week, the week of the year, the time of sunset, the time of sunrise, and the weather conditions (e.g., precipitation like rain, sleet, hail or snow).

In the closed position, (i) the front openable door overlies both the front wall aperture and the aperture frame of the front wall to block water and debris from entering the storage housing through the front wall aperture, and (ii) the rear openable door overlies both the rear wall aperture and the aperture frame of the rear wall to block water and debris from entering the storage housing through the rear wall aperture.

In the open position, (i) the front openable door is elevated above the front wall aperture to expose the front wall aperture to allow a desirable, preferred animal DPA to access feed located within the storage housing, and (ii) the rear openable door is elevated above the rear wall aperture to expose the rear wall aperture to allow the desirable, preferred animal DPA to access feed located within the storage housing.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTIONS OF THE DRAWINGS

The detailed description particularly refers to the accompanying figures in which:

FIG. 1 is a perspective view of an illustrative daytime animal feeder, in accordance with the present disclosure, in a closed position P_{C};

FIG. 2 is a cross sectional view of the daytime animal feeder taken along line 2-2 in FIG. 1;

FIG. 3 is an enlarged view of the daytime animal feeder of FIG. 1, showing a door of the feeder in the closed position P_{C};

FIG. 4 is a side elevation view of the daytime animal feeder of FIG. 1;

FIG. 5 is an enlarged view of an upper portion of the daytime animal feeder of FIG. 4;

FIG. 6 is a perspective view of the daytime animal feeder, showing both doors of the feeder in an open position P_{O};

FIG. 7 is a cross sectional view of the daytime animal feeder taken along line 7-7 in FIG. 6;

FIG. 8 is an enlarged view the daytime animal feeder of FIG. 6, showing both doors of the feeder in the open position P_{O};

FIG. 9 is an enlarged view of a portion of the daytime animal feeder of FIG. 6, showing an exterior surface treatment of a door of the feeder;

FIG. 10 is a perspective view of the daytime animal feeder of FIG. 1 with only one door elevated in the open position P_{O};

FIG. 11 is an elevated perspective view of the daytime animal feeder of FIG. 1 with both doors elevated in the open position P_{O};

FIG. 12 is a perspective view of the daytime animal feeder, showing the animal feeder in a wire frame drawing format and both doors in the closed position P_{C}; and

FIG. 13 is a perspective view of the daytime animal feeder, showing the animal feeder in a wire frame drawing format and both doors in the open position P_{O}.

### DETAILED DESCRIPTION

In the following detailed description of the daytime animal feeder 10, numerous specific details are set forth by way of examples in order to provide a thorough understanding of the relevant teachings. However, it should be apparent to those skilled in the art that the present teachings may be practiced without such details. In other instances, well-known methods, procedures, components, and/or circuitry have been described at a relatively high-level, without detail, in order to avoid unnecessarily obscuring aspects of the present teachings.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspects of the disclosed concepts to the embodiments illustrated. As will be realized, the disclosed daytime animal feeder 10 and the operational methods of same are capable of other and different configurations and several details are capable of being modified all without departing from the scope of the disclosed methods and systems. For example, one or more of the following embodiments of the daytime animal feeder 10, in part or whole, may be combined consistent with the disclosed methods and systems. As such, one or more steps from the operation of the feeder 10 or components of the feeder 10, including those shown in the Figures, may be selectively omitted and/or combined consistent with the disclosed methods and systems. Accordingly, the drawings, flow charts and detailed descriptions are to be regarded as illustrative in nature, not restrictive or limiting.

### A. INTRODUCTION

A daytime animal feeder 10 includes a feed storage bin or housing 12 having a wall arrangement 14 and at least one openable door 16, an actuator 15—namely, an actuator mechanism 18—configured to selectively open and close the at least one door 16 to allow a desirable, preferred animal DPA—namely, a livestock animal (e.g., horse, cow, cattle, sheep, goats) and/or game animal (e.g., deer, elk, turkey)—to access feed located within the storage housing 12, and a control system 20 configured to control operation of the actuator mechanism 18 to open and close the at least one door 16 based on one or more parameters or conditions defined by a user/owner of the animal feeder, or when the user manually triggers the actuator. Unlike conventional animal feeders, the inventive animal feeder 10 includes a number of components and features that are purposely designed to interact and provide improved daytime feeder performance including, but not limited to, preventing (i) unscheduled, uncontrolled feeding, (ii) water and/or moisture from penetrating or migrating into the storage housing 12 and damaging the animal feed therein, even when the at least one door is in either a closed position P_{C} or an open position P_{O}, and (iii) an undesirable, un-preferred animal UUA (e.g., hogs, boars, raccoons, squirrels, birds, etc.) from breaching the housing 12 to gain access to the feed and eat it.

### B. FEEDER STRUCTURE AND COMPONENTS

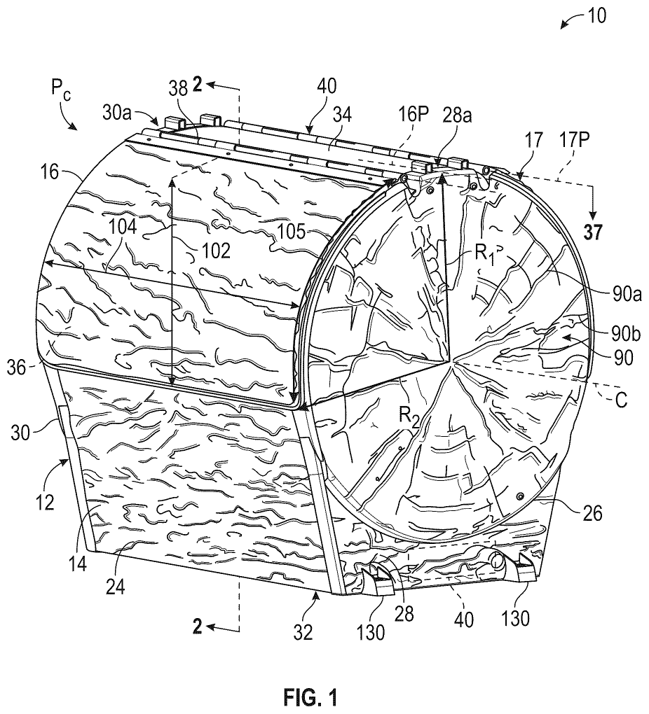

The wall arrangement 14 of the animal feeder 10 defines an interior space or cavity 22 to receive and store animal feed therein for daytime feeding by a desirable, preferred animal DPA. The wall arrangement 14 includes front and rear walls 24, 26, first and second end walls 28, 30 interconnecting the front wall 24 and the rear wall 26, and bottom and top walls 32, 34 interconnecting the end walls 28, 30 and the front and rear walls 24, 26 as shown in FIG. 1. As shown in FIGS. 1, 2 and 4, each of the end walls 28, 30 has an upper portion 28U, 30U and a lower portion 28L, 30L, where the upper portion 28U, 30U has a substantially circular periphery that corresponds to a cross section of a tree, namely a mature tree, to ensure that the feeder 10 blends in with outdoor, wooded areas. Alternatively, the upper portion 28U, 30U of the end walls 28, 30 has a curvilinear periphery that is non-circular, such as oval or irregular, or a linear or substantially linear periphery. The lower portion 28L, 30L of the end walls 28, 30 has a generally trapezoidal shape adjacent to the substantially circular shape of the upper portion 28U, 30U. In another embodiment of the feeder 10 (not shown), the end walls 28, 30 have a hemispherical periphery, instead of a circular periphery. When the base chord of the hemispherical end walls 28, 30 is vertically oriented (with respect to the bottom wall 40 that rests upon a supporting ground surface), the housing 12 may include only one openable door 16 and one aperture 36 that a head of the desired preferred animal DPA extends through to reach and consume the feed in the cavity 22, as discussed below. When the base chord of the hemispherical end walls 28, 30 is horizontally oriented (with respect to the bottom wall 40 that rests upon a supporting ground surface), the housing 12 may include at least one openable door 16, 17 and at least one aperture 36, 37 that a head of the desired preferred animal DPA extends through to reach and consume the feed in the cavity 22, as detailed below.

The bottom wall 32 forms a lowermost portion of the storage housing 12 and is adapted to rest on a support surface or ground, such as grass or soil. The top wall 34 extends between upper portions 28U, 30U of the end walls 28, 30, has a substantially rectangular configuration, and is configured to support the at least one openable door 16 of the feeder 10. At least one of the walls, illustratively the first end wall 28, is formed to include a clean-out panel 40 that can be detached to allow old feed to be removed from the interior space 22 and replaced by new feed. A plurality of feet 130 are coupled to the bottom wall 32 and the end walls 28, 30 to stabilize the feeder on the support surface or ground. Also, each foot 130 can receive an extent of an extension leg (not shown) that elevates the feeder 10 above the ground.

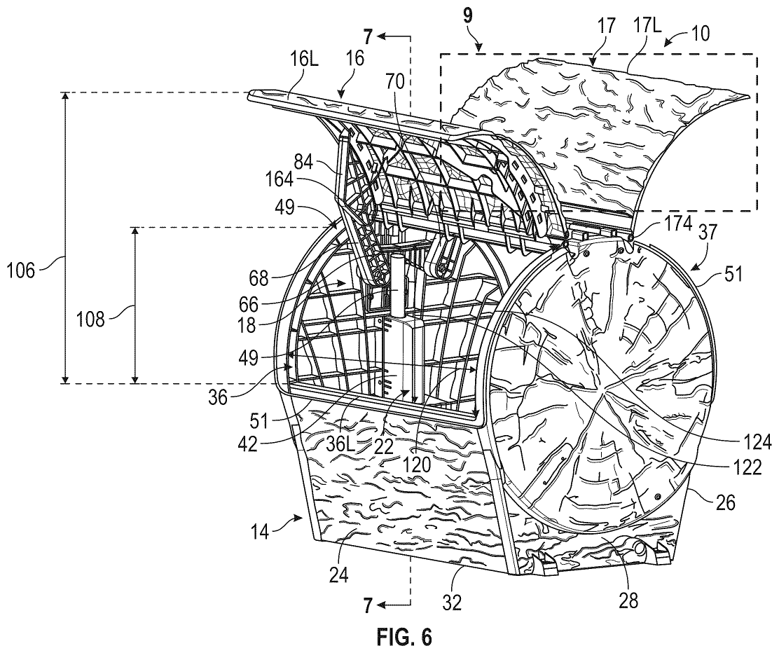

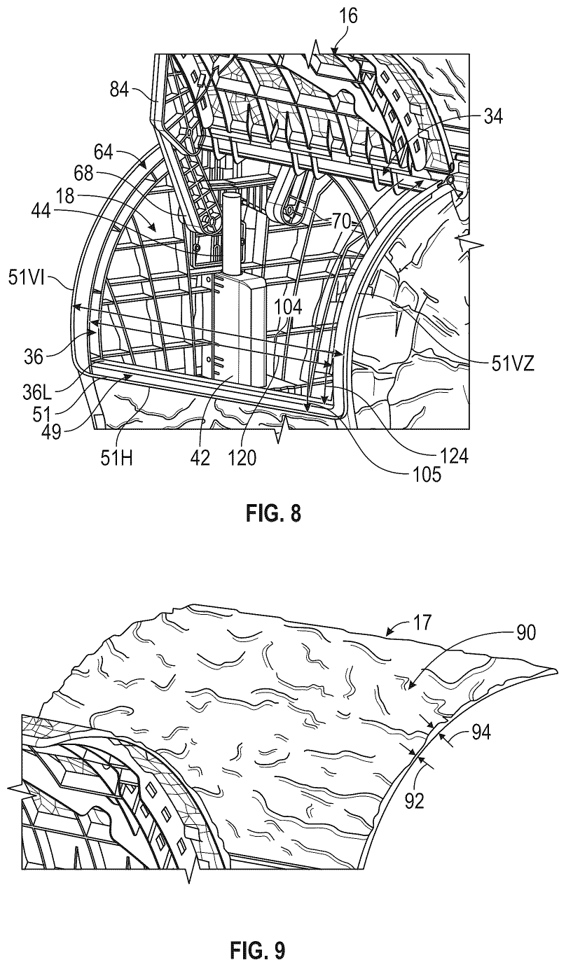

At least one of the front wall 24 and the rear wall 26 includes an access window or aperture 36 that is enclosable by the first door 16. In the open position P_{O} depicted in FIGS. 6-11, the aperture 36 allows a head of the desired preferred animal DPA to extend through the aperture 36 and reach and consume the feed in the cavity 22. In the illustrative embodiment, the rear wall 26 is also formed to include an access window or aperture 37 that is enclosable by a second openable door 17. The bottom and side (i.e., left and right) regions of the apertures 36, 37 are defined with the front and rear walls 24, 26, respectively. The top region of the apertures 36, 37 is defined by the top wall 34. Alternatively, the apertures 36, 37 are repositioned such that they are defined entirely within the arranged entirely within the front and rear walls 24, 26, respectively, and not the top wall 34.

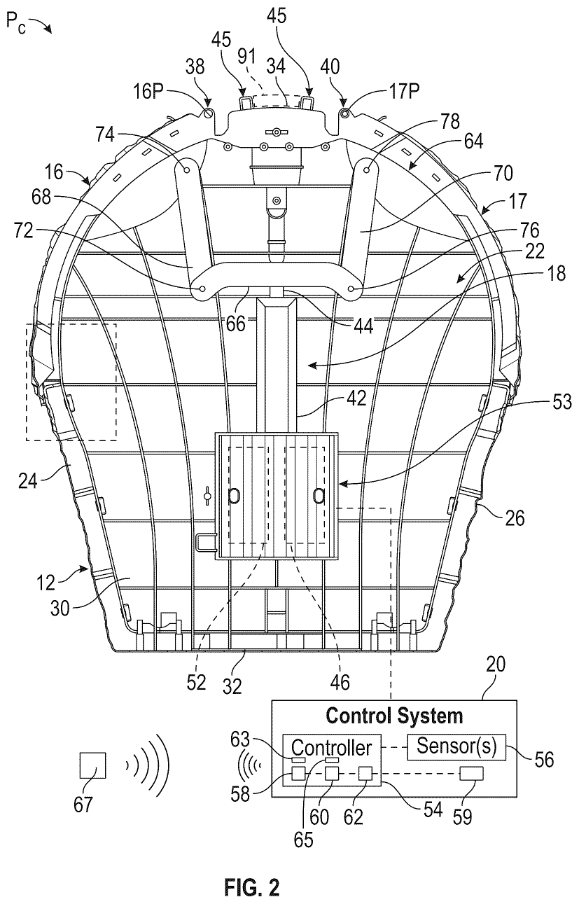

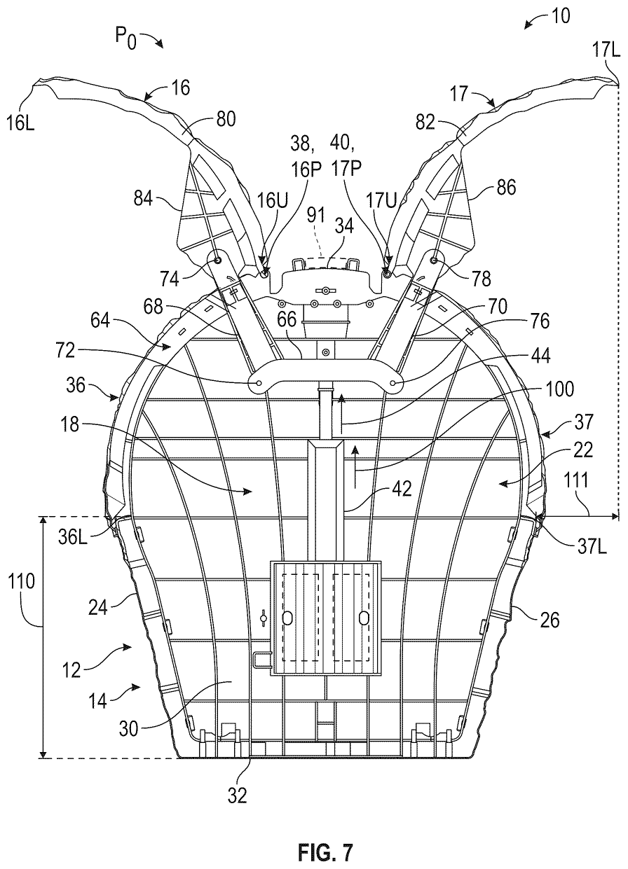

In the open position P_{O}, the second aperture 37 allows a head of a second desired preferred animal DPA to extend through the aperture 37 and reach and consume the feed in the cavity 22, whereby two desired preferred animals DPAs can simultaneously consume feed in the housing 12. Each of the apertures 36, 37 has substantially the same shape such that feeder 10 is symmetrical about the top wall 34 between the end walls 28, 30. Both of the first and second openable doors 16, 17 are also pivotally supported by a hinge 38, 40 located in the top wall 34 and are spaced apart from each other on an opposite side of the top wall 34. As shown in at least FIGS. 6 and 7, the first or front openable door 16 has a curvilinear configuration that matches the curvature of the upper portion of the front wall 24 and the second or rear openable door 17 has a curvilinear configuration that matches the curvature of the upper portion of the rear wall 26, respectively. Each of the openable front and rear doors 16, 17 also has a center of curvature in substantially the same location as a center C of the generally circular shaped upper end wall portions 28U, 30U when the openable doors 16, 17 are in the closed position P_{C} (see FIGS. 1 and 2). Thus, the center C is spaced a first radius R₁ from the center C to the top wall 34 and a second radius R₂ that is substantially the same as the first radius R₁ from the center C to the openable door 16, 17. In the illustrative embodiment, the radii R₁, R₂ are each approximately 30 inches. In some embodiments, the radii R₁, R₂ are each 4-40 inches.

The first and second openable doors 16, 17 have a lower end 16L, 17L and an upper portion 16U, 17U, where these relative positioning descriptions are based upon their orientation in the closed position P_{C}, and where the lower end 16L, 17L behaves as a free end because it is not pivotally connected by the hinge 38, 40 to the top wall 34. In the open position P_{O}, the lower or free, outer end 16L, 17L of each openable door 16, 17 is positioned substantially above (i) an opposite, upper or inner end 16U, 17U and (ii) the top wall 34 of the housing 12, as shown in FIGS. 6 and 7. In the embodiment of the Figures, the outer end 16L of the front openable door 16 and the outer end 17L of the rear openable door 17 are positioned or reside at the same vertical height above the top wall 34 of the housing 12. In this manner, the front and rear doors 16, 17 exhibit a “butterfly” movement with respect to the top wall 34 as the doors 16, 17 are pivotally displaced between the closed position P_{C} and the open position P_{O}. This positional arrangement provides room for animals with antlers or large heads to access the feed in the interior space 22 without their antlers interfering with the openable doors 16, 17. In the open position P_{O}, the free, outer end 16L, 17L of each door 16, 17 is spaced apart from a lower end 36L, 37L of each corresponding aperture 36, 37 by a first distance 106, while the upper or inner end 16U, 17U of each door 16, 17 is spaced apart from the lower end 36L, 37L of each corresponding aperture 36, 37 by a second distance 108. The first distance 106 is greater than the second distance 108. In the embodiment of the Figures, the first distance 106 is 25-30 inches, preferably 27-29 inches and most preferably 27.5 inches, and the second distance 108 is 14-20 inches, preferably 15-19 inches and most preferably 16 inches. In the closed position P_{C}, each of the free, outer ends 16L, 17L are positioned below the upper ends 16U, 17U and the lower ends 36L, 37L of the apertures 36, 37. The lower end 36L, 37L of each aperture 36, 37 is also spaced well above the bottom wall 32 of the storage housing 12 as shown in FIG. 7. This prevents an undesirable, unpreferred animal UUA from reaching the feed within the interior space 22. In the illustrative embodiment, the lower ends 36L, 37L are spaced apart from the bottom wall 32 by a distance 110 that is within a range of about 15-24 inches. The distance 110 may be at least 15 inches in some embodiments.

The components of the feeder 10 are purposely designed and arranged to prevent water (e.g., rain, sleet, hail, snow) or moisture from migrating into the housing 12 in the closed position P_{C} and damaging the feed stored therein. As a first example, each openable door 16, 17 has a set of dimensions, namely a height 102 and a width 104 and an arc length 105. Referring to FIG. 6, each aperture 36, 37 also has a set of dimensions, namely a height 122, a width 120 and an arc length 124. Referring to FIGS. 1-6, the dimensions of the door 16, 17 exceed the dimensions of the aperture 36, 37 whereby the respective door 16, 17 fully overlies or encloses the aperture 36, 37 in the closed position P_{C} to block water, moisture and debris from entering the housing 12 through the aperture 36, 37.

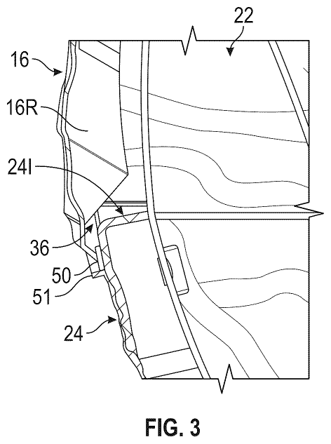

As a second example and referring to FIG. 6, the front and rear walls 24, 26 each include an aperture frame 49 and a U-shaped flange 51 extending along and outward from the aperture frame 49 of the front and rear walls 24, 26. The aperture frame 49 provides substantially flat interface areas for mating with at least an inner edge of each respective door 16, 17. The aperture frame 49 also surrounds/defines the lower edge region and the two opposed side edge regions of each respective aperture 36, 37. The flange 51 extends outward from an exterior surface of each the aperture frame 49 and an openable door 16, 17 is inset with respect to the flange 51 in the closed position P_{C}. In other words, the door 16, 17 is positioned against and within the flange 51 in the closed position P_{C}. As shown in FIG. 3, the feeder 10 may include a gasket 50 at each interface between the openable doors 16, 17 and the aperture frame 49 to help form a seal there between in the closed position P_{C}. The U-shaped flange 51 includes a horizontal flange portion 51H, a first vertical or side flange portion 51V1, and a second vertical or side flange portion 51V2. The horizontal flange portion 51H is slightly angled downwardly as shown in FIG. 3 to provide a rain gutter about the aperture 36, 37. In this manner, at least the lower edge segment of the openable door 16, 17 is adjacent to the horizontal flange portion 51H and lateral side edges of the openable door 16, 17 are adjacent to the vertical flange portions 51V1, 51V2 in the closed position P_{C}. Each openable door 16, 17 further includes a plurality of interior reinforcement ribs 16R that are inset to an intermediate segment 241, 261 of the front and rear wall 24, 26 in the closed position P_{C}.

The components of the feeder 10 are also purposely designed and arranged to prevent water (e.g., rain, sleet, hail, snow) from entering through the apertures 36, 37 in the open position P_{O} (shown in FIGS. 6-11) and damaging the feed stored within the housing 12 without compromising the construction, performance or utility of the feeder 10. Referring to FIG. 7, the first and second doors 16, 17 are designed to purposely overhang or overlie the apertures 36, 37 in the open position P_{O} such that rainfall that is oriented substantially downward and perpendicular to the housing 12, namely the top wall 34 of the housing 12, cannot enter the apertures 36, 37. As such, the free, outer end 16L, 17L of each door 16, 17 extends outward from the lower outer aperture edge 36L, 37L, respectively, to define a lateral overhang distance 111 (see FIG. 7) that is at least 1 inch, preferably 2-10 inches and most preferably 4-7 inches to prevent downwardly directed rain from entering the apertures 36, 37 to damage the feed stored in the housing 12. The overhang distance 111 increases the overall width of the housing 12 in the open position P_{O} and may limit certain installation locations for the feeder 10, however, these aspects are outweighed by the rain prevention benefits of the overhang distance 111.

The top wall 34 of the feeder 10 is formed to include a pair of recessed channels 35, 37 located adjacent to the hinges 38, 40 as shown in FIG. 5. Specifically, the top wall 34 is formed to include a first channel 35 adjacent the first hinge 38 interconnecting the first door 16 to the top wall 34 and a second channel 37 adjacent the second hinge 40 interconnecting the second door 17 to the top wall 34. The channels 35, 37 are located adjacent to the hinges 38, 40 to guide rain water away from the hinges 38, 40 so that the rain water does not penetrate through gaps in the hinges or between the top wall 34 and the doors 16, 17. The first channel 35 is located between the first hinge 38 and the second channel 37, while the second channel 37 is located between the second hinge 40 and the first channel 35. The top wall 34 may taper downward in a direction parallel with a door pivot axis 16P, 17P—that is defined by the hinge 38, 40, respectively—to guide water out of the channels 35, 37 at both ends of the top wall 34.

In some embodiments, the feeder 10 includes a waterproof sheet or flashing 39 that spans and covers the hinges 38, 40 as shown in FIGS. 5 and 11. The waterproof sheet 29 is coupled to attachment flanges 41, 43 extending outward from an exterior surfaces of an upper region of each door 16, 17. The waterproof sheet 39 may be a vinyl or rubber sheet that is flexible to allow for and not compromise pivotal movement of the doors 16, 17. The top wall may further include upwardly extending spacers or loops 45 that provide spacing between each hinge 38, 40 and the waterproof sheet 39 to block the waterproof sheet from interfering with the opening of the doors 16, 17. In the open position P_{O}, the waterproof sheet 39 may bunch up and drop into the first and second channels 35, 37 whereby the channels 35, 37 provide space to receive and accommodate an extent of the waterproof sheet 39. In addition, the spacers 45 have an inverted U-shape loop to provide an attachment location for an accessory awning extending upward from the top wall 34 and that can completely cover the animal feeder 10 from inclement weather.

The wall arrangement 14 and each of the openable doors 16, 17 are made from a polymeric material such as a high-density polyethylene or a polyurethane that is injection molded into each panel's specific shape and structure. Referring to FIGS. 1, 9 and 10, the components of the housing 12 and the wall arrangement 14, including the doors 16, 17 and the first and second end walls 28, 30, are formed with an exterior surface treatment that provides an exterior surface topography 90 that is textured with a substantially random arrangement of raised segments 90a and recessed segments 90b. Thus, the surface topography 90 mimics bark on a mature tree or log in a wooded environment. The surface topography 90 can be provided by maintaining or varying wall thicknesses 92, 94 in each panel of the wall arrangement 14 and the doors 16, 17. The raised segments 90a can have a height of 0.125-0.5 inch and the recessed segments 90b can have a depth of 0.125-0.25 inch.

### C. FEEDER OPERATION AND FUNCTIONALITY

Each of the openable doors 16, 17 is mounted to the housing 12, preferably at the top wall 34, by a hinge 38, 40 to allow for pivotable movement of each openable door 16, 17 about a respective door pivot axis 16P, 17P between the closed position P_{C} (as shown in FIGS. 1-5) and the opened position P_{O} (as shown in FIGS. 6-9). Other conventional feeders use a sliding door that laterally slides along a rail/channel but this type of door allows rain to penetrate the housing and damage the feed stored within the feeder.

Referring to FIGS. 2 and 6-8, the actuator mechanism 18 is configured to pivotally move and elevate each openable door 16, 17 about their respective door pivot axis 16P, 17P. In the embodiment shown in the Figures, the actuator mechanism 18 includes (i) an actuator housing 42, (ii) an actuator rod 44, and (iii) a power source 46. The actuator housing 42 is fixed to the storage housing 12 in the interior space 22. The actuator rod 44 is powered and vertically displaced by the power source 46 to move relative to the actuator housing 42 when the actuator mechanism 18 is activated to pivot at least one of the openable doors 16, 17 between the open position P_{O} and the closed position P_{C}. Unlike conventional feeders, the actuator rod 44 is vertically displaced in the upward direction by the power source 46 relative to the actuator housing 42 to move the doors 16, 17 from the closed position P_{C} to the open position P_{O}. Conversely, the actuator rod 44 is vertically displaced in the downward upward direction by the power source 46 relative to the actuator housing 42 to move the doors 16, 17 from the open position P_{O} to the closed position P_{C}. Other examples of the linear actuator 15 beyond the electro-mechanical actuator mechanism 18 include the following types of actuators: hydraulic, pneumatic, electrical, or magnetic. Additionally, the actuator mechanism 18 may include a spring, pulleys, gears, augers, screws and/or cables.

The power source 46 is an internal battery so that the feeder 10 can be placed in remote locations where grid power is not available. In other embodiments, the actuator mechanism 18 may be powered by a separate power source such as a power cord connected to an electrical outlet or a generator. The feeder 10 may further include a solar panel 91, coupled to the top wall 34, for example, and that is configured to power and recharge the internal battery power source 46.

The actuator rod 44 may be coupled directly to one or more of the doors 16, 17, however, in the illustrative embodiment, the actuator mechanism 18 can includes a synchronization mechanism 64 that transfers motion from the actuator rod 44 to each of the openable doors 16, 17 at the same time. The synchronization mechanism 64 includes a yoke 66 coupled to a distal end of the actuator rod 44 and first and second link arms 68, 70 interconnecting the yoke 66 to each respective door 16, 17. The yoke 66 forms a T-shape with the actuator rod 44 such that both ends of the yoke 66 extend away from the actuator rod 44 as shown in FIG. 2. The first link arm 68 is coupled to a first end of the yoke 66 at a first pivot point 72 defining a first pivot axis and to the first openable door 16 at a second pivot point 74 defining a second pivot axis, wherein the first pivot point 72 and the second pivot point 74 are located at opposed end portions of the first link arm 68. The second link arm 70 is coupled to an opposite, second end of the yoke 66 at a third pivot point 76 defining a third pivot axis and to the second openable door 17 at a fourth pivot point 78 defining a fourth pivot axis, wherein the third pivot point 76 and the fourth pivot point 78 are located at opposed end portions of the second link arm 70.

The actuator rod 44 is movable upwardly in a linear direction 100 to open each of the openable doors 16, 17 as shown in FIGS. 6 and 7. The actuator rod 44 may be mechanically or pneumatically actuated in the direction 100. The yoke 66 is configured to drive each of the link arms 68, 70 upwardly with movement of the actuator rod 44. Each of the link arms 68, 70 pivot about each respective axis 72, 74, 76, 78 as the doors 16, 17 move from the closed position P_{C} to the open position P_{O}. Each of the doors 16, 17 includes a door panel 80, 82, and an arm mount 84, 86 coupled to an underside of the door panel 80, 82. Each link arm 68, 70 is configured to couple to a respective arm mount 84, 86.

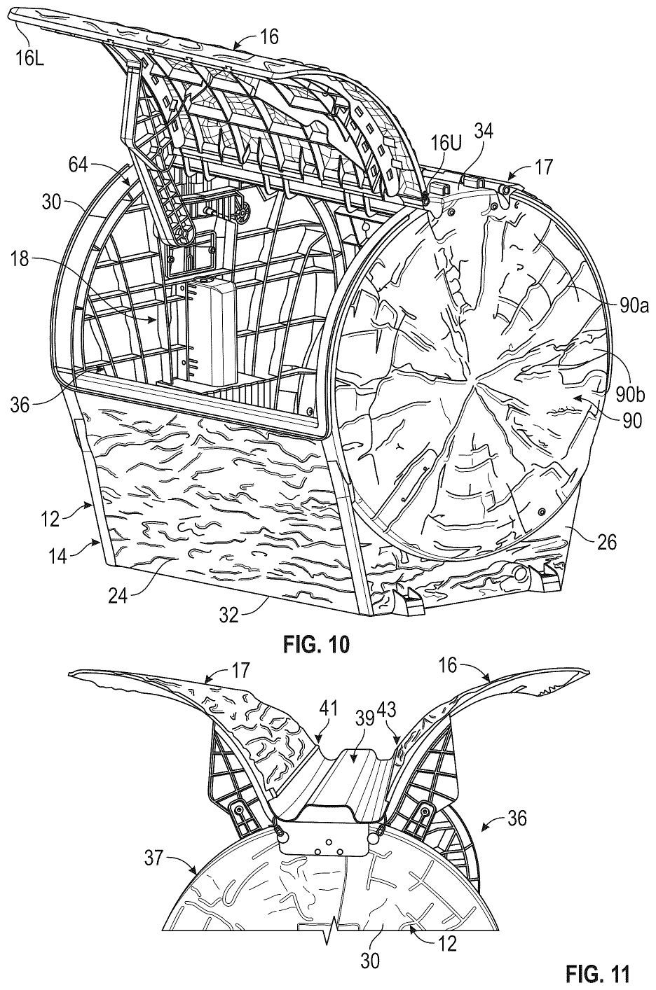

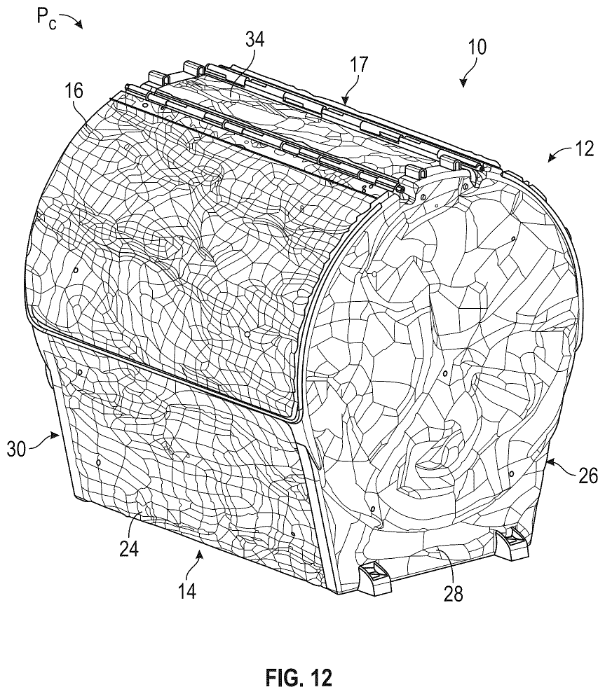

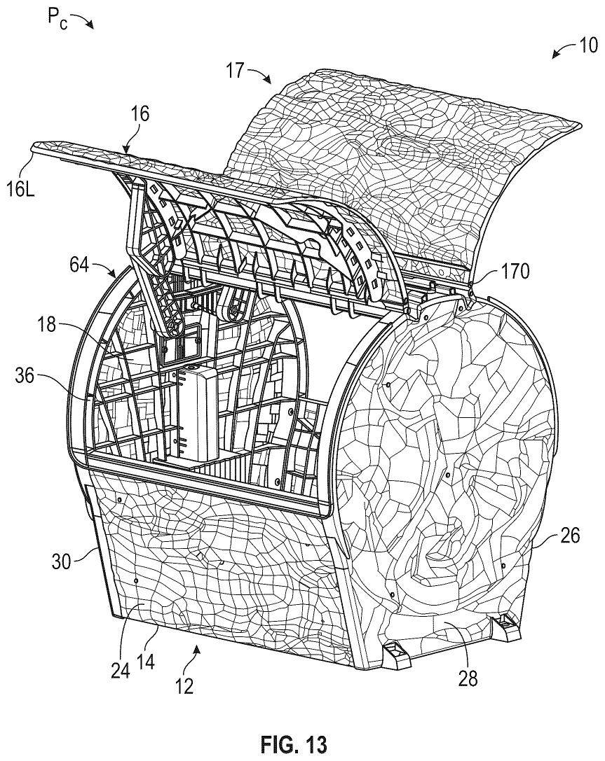

In some embodiments, the actuator mechanism may include separate rods or motors to individually actuate each door 16, 17 independently from one another as suggested in FIG. 10. Thus, the synchronization mechanism 64 may be removed in some embodiments. For example, one door 16 may be opened to expose an aperture facing away from the wind while the aperture facing toward the wind remains closed so that rain does not blow into the interior space 22.

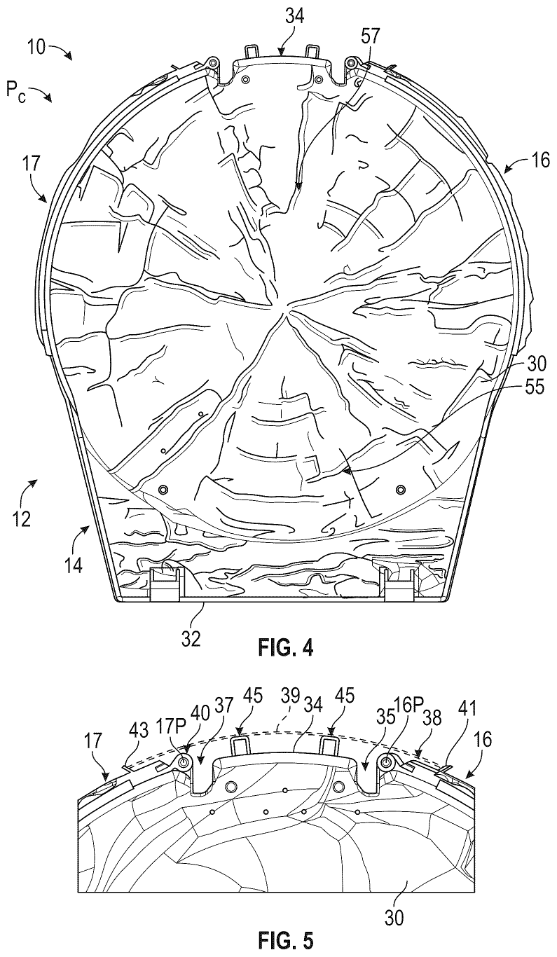

The actuator mechanism 18 is operatively connected to the control system 20 to receive commands therefrom to open and close at least one of the openable doors 16, 17. In one embodiment, the control system 20 includes a timer 52 and the control system 20 is configured to activate the actuator mechanism 18 in response to the timer 52 reaching a predetermined threshold/time. For example, the timer 52 can be programmed by a user to open at least one of the openable doors 16, 17 at sunrise and to close the openable doors 16, 17 at sunset to train animals to feed only during the day when hunting is permitted by local ordinances, rules and/or regulations. The timer 52 may be programmed with any opening/closing interval(s). The internal battery 46 and the timer 52 are both located within a compartment 53 formed into or coupled to one of the end walls 30. The internal battery and the time 52 are both accessible by removing an access panel 55 that forms a portion of the end wall 30 as shown in FIG. 4. The actuator mechanism 18 is accessible by removing an access panel 57 to allow for manual release of the actuator mechanism 18 so that the openable doors 16, 17 are free to pivot manually to the open position P_{O}. The control system 20 also includes a switch 59, located either within or on the housing 12 (e.g., mounted in the top wall 34 or one of the side walls 24, 26) that can be activated by the user to operate the actuator mechanism to displace the doors 16, 17 between the closed position P_{C} and the open position P_{O}. Alternatively, the switch 59 is located remote from, but in close proximity to, the feeder 10 such the user can operate the actuator mechanism to displace the doors 16, 17 as the desirable, preferred animal DPA approaches or departs the area proximate the feeder 10.

Referring again to FIG. 2, in some embodiments of the feeder 10, the control system 20 may communicate with wireless devices and may further include or be replaced with a controller 54 and a sensor assembly 56 including at least one sensor. The controller 54 includes a processor 58, a memory storage device 60, and circuitry 62. The processor 58 is configured to execute commands to control operation of the actuator mechanism 18 in response to one or more user inputs and/or sensor inputs from the sensor assembly 56. The memory storage device 60 is coupled communicatively to the processor 58 and stores instructions that are executable by the processor 58. The circuitry 62 interconnects each of the components of the controller 54, the sensor assembly 56, and the actuator mechanism 18 to allow the communication of commands and/or data there between. The controller 54 also includes one or more transceivers 63 and/or antennas 65 to allows wireless communication with at least one remote device 67 such as a smart phone, computer, tablet or remote control utilized by one or more users to provide operating inputs to the feeder 10.

The control system 20, including the controller 54, may activate the actuator mechanism 18 in response to one or inputs from the user's remote device 67, such as the user's phone. The user inputs can include a command to open or close at least one of the openable doors 16, 17 from a remote location. The user inputs can include an input setting a specific time(s) or date (or both) that at least one of the openable doors 16, 17 opens and closes. The selected time(s) may be recorded in the memory storage device 60 or in the timer 52.

The controller 54 may also automatically operate the actuator mechanism 18 in response to one or more sensed conditions from the sensor assembly 56. For example, the sensor assembly 56 may include one or more of a photodiode, photoresistor, phototransistor, or photovoltaic light sensor to detect sunrise and sunset conditions. In response to a determination that sunrise has occurred, the controller 54 may be configured to output a commend to the actuator mechanism 18 to open one or more of the openable doors 16, 17. In response to a determination that sunset has occurred, the controller 54 may be configured to output a commend to the actuator mechanism 18 to close the openable doors 16, 17. The sensor assembly 56 may include a motion sensor and the controller 54 may open one or more doors 16, 17 or close the doors 16, 17 in response to sensed motion, or lack thereof, around the feeder 10. In another example, the sensor assembly 56 includes at least one camera that takes still pictures and/or video of the desirable, preferred animal DPA that has triggered the sensor assembly 56 to operate the actuator mechanism 18 to displace the doors 16, 17 between the closed position P_{C} and the open position P_{O}. The camera of the sensor assembly 56 takes still pictures and/or video of the desirable, preferred animal DPA as it is consuming feed from the feeder 10, as well as images of the DPA approaching and departing the feeder 10. These images of the DPA include a location, date and time stamp, which are then stored in the memory storage device 60 as an “Alert Event.” The controller 54, namely the transceiver 63 and the antenna 65, transmit an “Alert” to the user's remote device 67 along with the Alert Event details and any pictures and/or video of the desirable, preferred animal DPA.

The sensor assembly 56 may include one or more weather-related sensors (i.e. a barometer, rain gauge, temperature sensor, humidity sensor, etc.) and the controller 54 may open one or more doors 16, 17 in response to favorable weather (i.e. no rain) or close the doors 16, 17 in response to unfavorable weather (i.e. rain). As one example, if these weather-related sensors 56 detect rain or high humidity conditions, then the controller 54 operates the actuator mechanism 18 to move the doors 16, 17 from the open position P_{O} to the closed position P_{C}, which can include overriding instructions stored in the memory device 60 remain in the open position P_{O}, due to the inclement weather, thereby preventing feed from being damaged by the water or humidity. Information from a database related to weather may be sent to the control system 20, including the controller 54, such that it may selectively operate the actuator mechanism 18 in response to the information.

Headings and subheadings, if any, are used for convenience only and are not limiting. The word exemplary is used to mean serving as an example or illustration. To the extent that the term includes, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure. It is to be understood that the invention is not limited to the exact details of construction, operation, exact materials or embodiments shown and described, as obvious modifications and equivalents will be apparent to one skilled in the art. Accordingly, the invention is therefore to be limited only by the scope of the appended claims. While the specific embodiments have been illustrated and described, numerous modifications come to mind without significantly departing from the spirit of the invention, and the scope of protection is only limited by the scope of the accompanying Claims.

1. An animal feeder that provides controlled feeding for an animal, the animal feeder comprising:
a wall arrangement defining a housing configured to store animal feed, the housing including:
a front wall with a front wall aperture defined by an aperture frame of the front wall,
a front openable door pivotally coupled to the housing and overlying both the front wall aperture and the aperture frame of the front wall;
an actuator configured to pivotally move the front openable door between a closed position and an open position;
a control system configured to control operation of the actuator in response to one or more predefined conditions; and,
wherein: (i) in the closed position, the front openable door overlies both the front wall aperture and the aperture frame of the front wall to block water and debris from entering the storage housing through the front wall aperture, and (ii) in the open position, the front openable door is elevated above the front wall aperture to expose the front wall aperture to allow a desirable, preferred animal DPA to access feed located within the storage housing, while a lower end of the front openable door extends outward of a lower outer edge of the front wall aperture.

2. The animal feeder of claim 1, wherein in the open position, the lower end of the front openable door extends outward of the lower edge of the front wall aperture to define a lateral overhang distance that is at least one inch.

3. The animal feeder of claim 2, wherein the lateral overhang distance that is 2-10 inches.

4. The animal feeder of claim 2 wherein the lateral overhang distance that is 4-7 inches.

5. The animal feeder of claim 1, wherein the housing further includes a rear wall with a rear wall aperture defined by an aperture frame of the rear wall, and wherein the rear wall aperture is in an opposed positional relationship to the front wall aperture.

6. The animal feeder of claim 5, wherein the housing further includes a rear openable door pivotally coupled to the housing and overlying both the rear wall aperture and the aperture frame of the rear wall.

7. The animal feeder of claim 6, wherein the actuator is configured to move the rear openable door between a closed position and an open position, and wherein the control system is configured to control operation of the actuator in response to one or more predefined conditions.

8. The animal feeder of claim 7, wherein (i) in the closed position, the rear openable door overlies both the rear wall aperture and the aperture frame of the rear wall to block water and debris from entering the storage housing through the rear wall aperture, and (ii) in the open position, the rear openable door is elevated above the rear wall aperture to expose the rear wall aperture to allow a desirable, preferred animal DPA to access feed located within the storage housing, while a lower end of the rear openable door extends outward of a lower outer edge of the rear wall aperture.

9. The animal feeder of claim 6, wherein the housing further includes a first end wall and a second end wall that interconnect the front and rear walls of the housing.

10. The animal feeder of claim 9, wherein first end wall and the second end wall have an upper portion with substantially circular periphery.

11. The animal feeder of claim 10, wherein first end wall and the second end wall have a lower portion with a generally trapezoidal shape adjacent to the substantially circular shape of the upper portion.

12. The animal feeder of claim 5, wherein the housing further includes a top wall residing between the front wall and the rear wall, wherein the front openable door is pivotally coupled to a front segment of the top wall and the rear openable door is pivotally coupled to a rear segment of the top wall.

13. The animal feeder of claim 12, wherein the front openable door is pivotally coupled to the front segment of the top wall by a first hinge that extends along said front segment, and wherein the rear openable door is pivotally coupled to a rear segment of the top wall by a second hinge that extends along said rear segment of the top segment.

14. The animal feeder of claim 13, wherein the first hinge and the second hinge are arranged in a substantially parallel relationship on the top wall.

15. The animal feeder of claim 13, wherein the first hinge and the second hinge extend a longitudinal axis of the top wall.

16. The animal feeder of claim 12, wherein in the open position, a free, outer end of the front openable door and a free, outer end of the rear openable door are elevated above the top wall of the housing.

17. The animal feeder of claim 16, wherein the free, outer end of the front openable door and the free, outer end of the rear openable door reside at the same height above the top wall of the housing.

18. The animal feeder of claim 12, wherein the top wall includes at least one channel extending along a length of the top wall and being configured to drain water that accumulates on the top wall.

19. The animal feeder of claim 12, further comprising a waterproof flashing extending over the top wall of the housing.

20. The animal feeder of claim 1, wherein an outer surface of the housing has an exterior surface topography that is textured with an arrangement of raised segments and recessed segments.
